(19) United States
(12) Patent Application Publication
(10) Pub. No.: US 2018/0182111 A1
(43) Pub. Date: Jun. 28, 2018

(54) ILLUMINATION SYSTEM, ILLUMINATION METHOD, AND PROGRAM

(71) Applicant: PANASONIC INTELLECTUAL PROPERTY MANAGEMENT CO., LTD., Osaka (JP)

(72) Inventors: Toshiaki SHINOHARA, Fukuoka (JP); Yuumi MIYAKE, Fukuoka (JP); Jyouji WADA, Fukuoka (JP); Takayuki SHIMAOKA, Fukuoka (JP)

(73) Assignee: PANASONIC INTELLECTUAL PROPERTY MANAGEMENT CO., LTD., Osaka (JP)

(21) Appl. No.: 15/846,454

(22) Filed: Dec. 19, 2017

(30) Foreign Application Priority Data
Dec. 28, 2016 (JP) 2016-256844

(51) Int. Cl. G06T 7/292; G06T 7/246; G06T 7/73; G06T 7/60; H04N 9/31; H05B 37/02

(52) U.S. Cl. CPC G06T 7/292; G06T 7/248; G06T 7/74; G06T 7/60; F21S 8/086; H05B 37/0227; G06T 2207/30196; G06T 2207/30232; H04N 9/3147

(57) ABSTRACT

In an illumination system, a plurality of cameras and a plurality of illumination devices that are installed in a sidewalk where a person moves are connected to a control device through a network. Each of the plurality of cameras transmits detection information including a position and a movement direction of the person to the control device. The control device selects the illumination device that illuminates a front of the person in the movement direction of the person, from among the plurality of illumination devices, based on the detection information which is transmitted from each of the cameras, and further instructs the selected illumination device to light up.

### BACKGROUND

### 1. Technical Field

The present disclosure relates to an illumination system which illuminates an area where a moving object moves, an illumination method, and a program.

### 2. Description of the Related Art

In the related art, for example, in a case of turning on street lamps for a moving object (for example, a pedestrian) walking on a sidewalk at night, if all the street lamps in the sidewalk are turned on regardless of presence or absence of the pedestrian, the total power consumption increases and it is inefficient. Therefore, it is preferable to turn on the street lamps, for example, at night, only in a case where there is the pedestrian.

A street lighting control device of PTL 1 (Japanese Patent Unexamined Publication No. 2009-259584) is proposed as a prior art aimed at eliminating unnecessary lighting on a street and saving electricity. In PTL 1, a street lighting control device includes an illumination sensor and a human sensor, and turns on a street lamp in a case of detecting an entry of a moving object such as a vehicle in a state where darkness of a surrounding area is detected.

However, in PTL 1, the street lighting control device turns on the street lamp on the assumption that a moving object such as a vehicle goes straight. Therefore, the vehicle often travels straight ahead, but in a case where the moving object is a pedestrian, the pedestrian (that is, a person) is not always merely moving straight ahead, but turns back on the way, stops temporarily, and walks in various aspects. As such, in PTL 1, there is a case where it is difficult to suitably illuminate the front of the pedestrian walking in various aspects. Specifically, it is considered that the pedestrian, for example, walks on a road branching complicatedly, changes a direction of walking to a road bent at a right angle according to road guidance to a store, and suddenly runs out due to a time limit. That is, an illumination device of related art cannot sufficiently grasp such movement of the pedestrian, and cannot perform the illumination in consideration of movement of a moving object such as a pedestrian.

### SUMMARY

The present disclosure is made in view of the aforementioned situation of related art, and an object of the present disclosure is to provide an illumination system which can perform illumination in consideration of movement of a person such as a pedestrian, an illumination method, and a program.

In the present disclosure, there is provided a plurality of cameras and a plurality of illumination devices that are installed in an area where a person moves are connected to a control device through a network, each of the cameras transmits detection information including a position and a movement direction of the person in the area to the control device, and the control device selects the illumination device that illuminates a region in front of the person in the area in the movement direction of the person, from among the plurality of illumination devices, based on the detection information which is transmitted from each of the cameras, and further instructs the selected illumination device to light up.

In addition, the present disclosure provides an illumination method of an illumination system in which a plurality of cameras and a plurality of illumination devices that are installed in an area where a person moves are connected to a control device through a network, and the illumination method includes transmitting detection information including a position and a movement direction of the person in the area to the control device by using each of the cameras, and selecting the illumination device that illuminates a region in front of the person in the area in the movement direction of the person, from among the plurality of illumination devices, based on the detection information which is transmitted from each of the cameras, and further instructing the selected illumination device to light up, by using the control device.

In addition, the present disclosure provides a recording medium in which a program that can be read by a computer is stored, the recording medium storing a program which causes a control device that is a computer and is connected through a network between a plurality of cameras and a plurality of illumination devices which are installed in an area where a person moves, to execute a step of selecting the illumination device that illuminates a region in front of the person in the area in the movement direction of the person, from among the plurality of illumination devices, based on the detection information which is transmitted from each of the plurality of cameras and includes a position and a movement direction of the person in the area, and a step of instructing the selected illumination device to light up.

According to the present disclosure, it is possible to perform illumination in consideration of movement of a person such as a pedestrian.

### BRIEF DESCRIPTION OF THE DRAWINGS

FIG. 1 is a block diagram illustrating an example of a configuration of an illumination system according to a first exemplary embodiment;

FIG. 2 is a block diagram illustrating an example of a configuration of a control device;

FIG. 3 is a view schematically illustrating appearance of a head of a lighting device;

FIG. 4 is a view illustrating an outline of a projection operation of the illumination system;

FIG. 5A is an explanatory view of a positional relationship between a pole and a camera, and is a view illustrating a case where the pole is within a photography angle of view of the camera;

FIG. 5B is an explanatory view of the positional relationship between the pole and the camera, and is a view illustrating a case where the pole is not within the photography angle of view by the capture of the camera;

FIG. 6A is a view illustrating an image captured by each of cameras provided in two lighting devices, and is the view illustrating the image captured by the camera of one of the lighting devices;

FIG. 6B is a view illustrating an image captured by each of the cameras provided in the two lighting devices, and is the view illustrating the image captured by the camera of the other lighting device;

FIG. 7 is a sequence diagram of an illumination operation of the illumination system according to the first exemplary embodiment;

FIG. 8 is a sequence diagram of a projection operation of the illumination system according to the first exemplary embodiment;

FIG. 9A is a view illustrating images captured in time series by the camera of the lighting device, and is the view illustrating the image captured at time t;

FIG. 9B is a view illustrating images captured in time series by the camera of the lighting device, and is the view illustrating the image captured at time t+1;

FIG. 10 is a view illustrating an outline of an illumination operation of a lighting device according to a second exemplary embodiment;

FIG. 11 is a flowchart illustrating an illumination operation sequence of an illumination system according to the second exemplary embodiment;

FIG. 12A is a view illustrating images captured in time series by the camera of the lighting device, and is the view illustrating the image captured at time t;

FIG. 12B is a view illustrating images captured in time series by the camera of the lighting device, and is the view illustrating the image captured at time t+1;

FIG. 13A is a view illustrating a first method of projecting a zebra pattern to obtain a height of a person, and is the view illustrating the lighting device and the person when viewed in a lateral direction;

FIG. 13B is a view illustrating the first method of projecting the zebra pattern to obtain the height of the person, and is the view illustrating the lighting device and the person when viewed from a top;

FIG. 14A is an explanatory view of a second method of projecting the zebra pattern to obtain the height of the person, and is a monitor screen displaying an image captured by the camera;

FIG. 14B is an explanatory view of the second method of projecting the zebra pattern to obtain the height of the person, and is the view illustrating a positional relationship between the lighting device, the camera, and the person;

FIG. 14C is a view illustrating a Y-Z plane of FIG. 14B;

FIG. 15A is an explanatory view of a third method of projecting the zebra pattern to obtain the height of the person, and is the view illustrating a projection position of a projector and an image capturing position of the camera;

FIG. 15B is an explanatory view of the third method of projecting the zebra pattern to obtain the height of the person, and is a view illustrating an image of the zebra pattern captured by the camera; and

FIG. 15C is an explanatory view of the third method of projecting the zebra pattern to obtain the height of the person, and is the view illustrating distortion of the zebra pattern in a case where there is an object surface in a projection direction of the projector.

### DETAILED DESCRIPTION

Hereinafter, each exemplary embodiment which specifically discloses an illumination system, an illumination method, and a program according to the present disclosure will be described in detail with reference to the drawings as appropriate. However, detailed explanation more than necessary may be omitted. For example, detailed description of well-known matters and repeated description on substantially the same configuration may be omitted. This is to avoid unnecessary redundancy of the following description and to facilitate understanding of those skilled in the art. The accompanying drawings and the following description are provided to enable those skilled in the art to fully understand the present disclosure, and are not intended to limit the subject matter described in the scope of claims.

### First Exemplary Embodiment

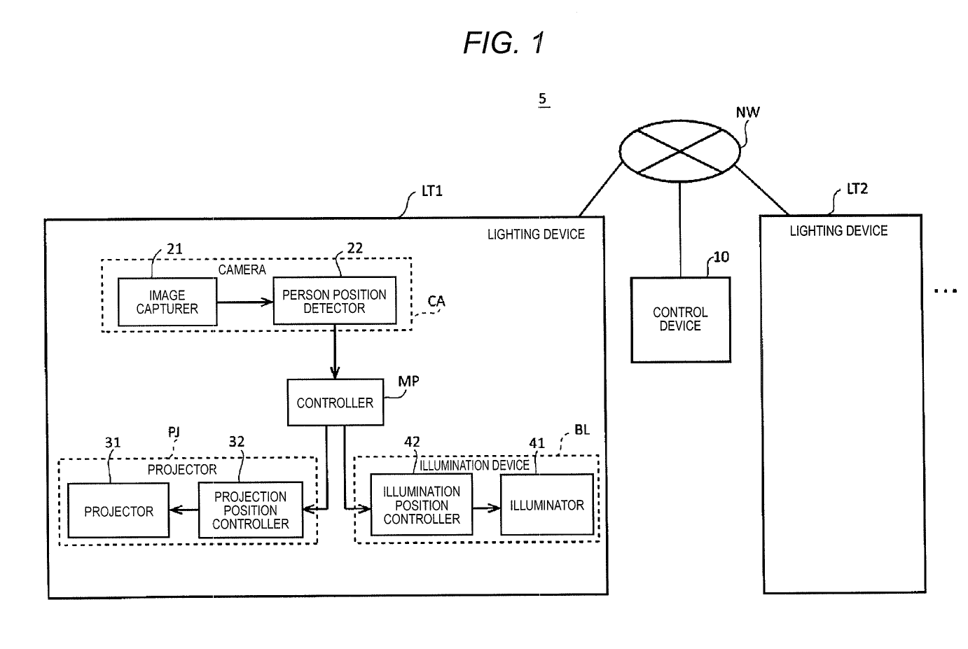

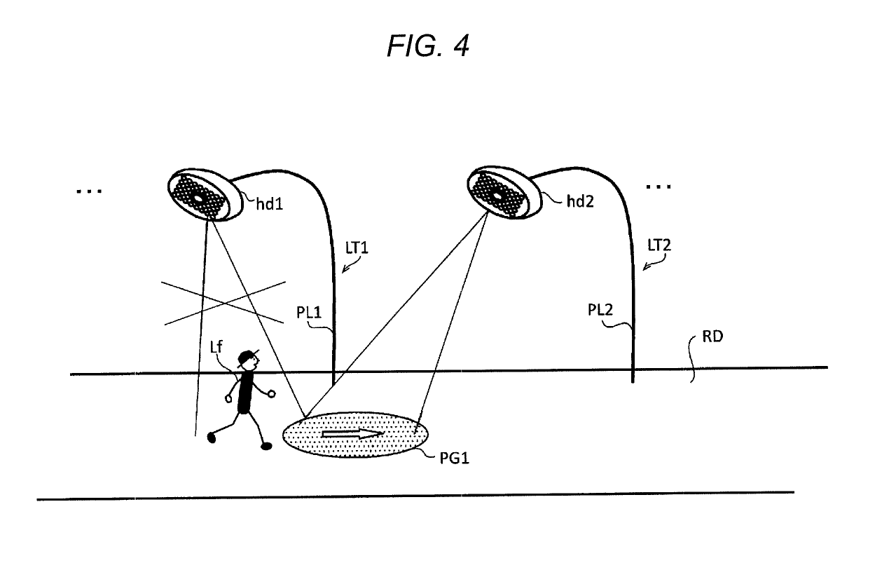

FIG. 1 is a block diagram illustrating an example of a configuration of illumination system 5 according to a first exemplary embodiment. Illumination system 5 is configured to include a plurality of lighting devices LT1 and LT2 and control device 10. The plurality of lighting devices LT1 and LT2 and control device 10 are connected so as to be able to transmit and receive information and data through network NW. The plurality of lighting devices LT1 and LT2 are installed at substantially equal intervals (including equal intervals) along, for example, sidewalk RD (see FIG. 4), and the number of lighting devices installed is not limited in particular. In a case where the plurality of lighting devices LT1 and LT2 are not required to be distinguished in particular, the lighting devices are simply referred to as lighting device LT.

Each lighting device LT includes camera CA, projector PJ, illumination device BL, and controller MP.

Camera CA as an example of a camera includes at least capture 21 and person position detector 22. Capture 21 captures an image of sidewalk RD (an example of an area) on which a person moves, and includes an optical lens, a lens control mechanism, an image sensor, and the like. The optical lens forms a subject image on an image sensor. The lens control mechanism includes a zoom mechanism that changes a focal distance by moving the optical lens in an optical axis direction. The image sensor is configured by using a charge coupled device (CCD) sensor or a complementary metal oxide semiconductor (CMOS) sensor. The image sensor includes an element capable of receiving near infrared so as to be capable of performing night image capturing in addition to an element capable of receiving visible light.

The person position detector 22 is configured by using, for example, a central processing unit (CPU), a micro processing unit (MPU)), or a digital signal processor (DSP), and is an image processor which processes an image captured by capture 21 to recognize a person. Person position detector 22 recognizes and determines a position (position information) and a movement direction (vector information) of a person by using, for example, an interframe difference of image frames obtained in time series. Person position detector 22 notifies controller MP of detection information including information on the position and movement direction of the person which are recognized.

Projector PJ as an example of a projection device includes at least projector 31 and projection position controller 32. Projector 31 projects a projection image (also simply referred to as a projection (PJ) image) onto a road surface of sidewalk RD where a person moves. The projection image (PJ image) may be an image such as an arrow mark indicating a travel direction on a sidewalk, an advertisement of a commodity or a service to a person, guidance useful for a person (including various messages), but it is needless to say that the projection image is not limited thereto.

Projection position controller 32 controls projector 31. Projection position controller 32 determines a position and a range of projection of the projection image, based on the position and movement direction of the person notified from controller MP, and instructs projector 31 to project the projection image onto the determined position and the determined range. For example, projection position controller 32 instructs projector 31 to project the projection image to a projection position in front of the person in a movement direction of the person. Projector 31 projects the projection image at a magnification expanding to the determined range onto the projection position (for example, 5 m ahead of a position of the person) in accordance with the instruction. The projection position may be a fixed value such as 3 m, 5 m or 10 m, or may be a changeable value. The projection range may be a constant size (fixed value) without depending on the projection position, and in which case, processing of determining the projection range is omitted.

In addition, projection position controller 32 may change the projection position in accordance with a walking speed (movement speed). For example, in a case where the walking speed of the person is slow, the projection position may be 1 m ahead of the position of the person, if the movement speed of the person is fast such as when the person is running, the projection position may be 10 m ahead of the position of the person.

In addition, projection position controller 32 may previously store the projection image (PJ image) projected by projector 31 in a memory, and may read and use the projection image in accordance with an instruction from control device 10, or may temporarily store and use the projection image (PJ image) transmitted from control device 10. In addition, the projection image (PJ image) may be the same image regardless of the projection position, or may be different images corresponding to the projection position. For example, projection position controller 32 can also switch the projection image projected in accordance with the movement (walking) of the person. In addition, the projection image (PJ image) may be projected by one lighting device LT, or may be projected by the plurality of lighting devices LT so as to partially overlap each other. In addition, projector 31 projects the projection image (PJ image) such that person Lf is not included in the projection position in front of the person Lf in the movement direction of the person. Projector 31 can project the projection image (PJ image) such that the person Lf is included.

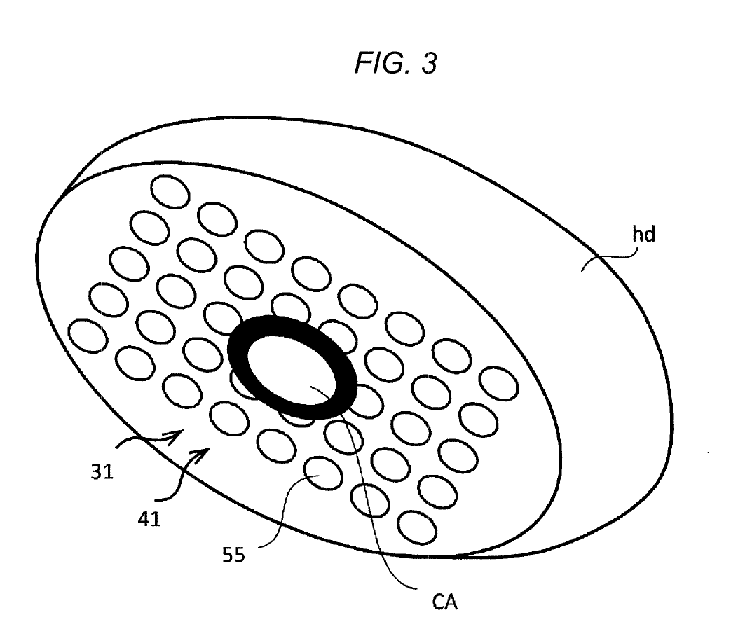

Illumination device BL includes at least illuminator 41 and illumination position controller 42. Illuminator 41 is disposed, for example, in head hd (see FIG. 3) of lighting device LT and includes a plurality of point light sources. In the present exemplary embodiment, light emitting diode (LED) 55 is used as the point light sources. The plurality of point light sources are two-dimensionally arranged over the entire region excluding the central portion of an irradiation surface of head hd. Illuminator 41 can individually set luminance of the plurality of point light sources in accordance with an instruction from illumination position controller 42. For example, in a case where only the point light source disposed above head hd is turned on, a region far from pole PL of lighting device LT can be illuminated, and meanwhile, in a case where only the point light source disposed below head hd is turned on, a region close to pole PL of lighting device LT can be illuminated. In addition, illuminator 41 can also light the central portion of the plurality of point light sources at high luminance and can light a peripheral portion thereof at low luminance. In the present exemplary embodiment, illuminator 41 uses the plurality of LEDs as point light sources, but is not limited to LEDs, and, for example, an organic EL, a liquid crystal display, a plasma display, or the like may be used as the light source. The plurality of point light sources may be two-dimensionally arranged over the entire region excluding the central portion of the irradiation surface of head hd, and may be used as projector 31 in addition to illuminator 41.

Illumination position controller 42 controls illuminator 41, determines an illumination position and an illumination range, based on the position and movement direction of the person notified by controller MP, and instructs illuminator 41 to illuminate the illumination position so as to expand in the determined range. The range of illumination may be a constant size (fixed value), and in which case, processing of determining the range is omitted. For example, illuminator 41 illuminates such that person Lf is included in the illumination position in front of the person Lf in the movement direction of the person. Illuminator 41 may illuminate only the front without including the person Lf.

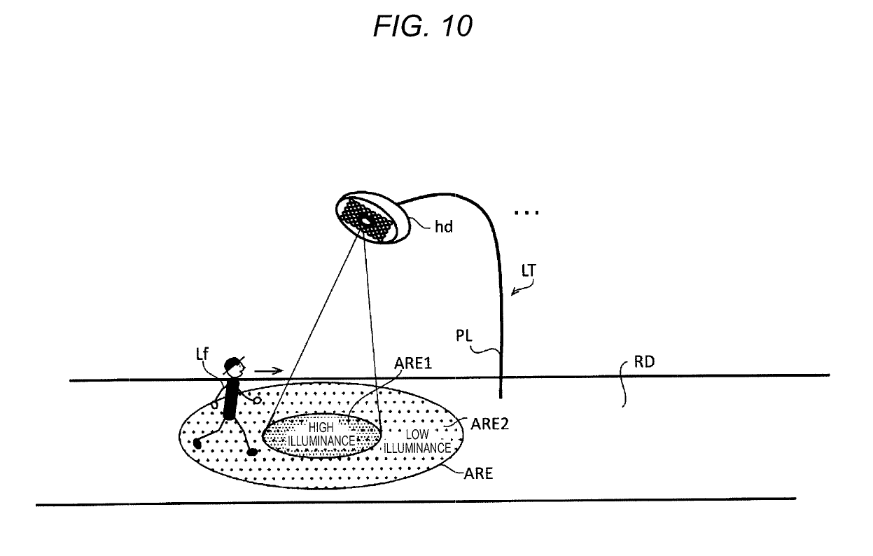

In addition, illumination position controller 42 illuminates front area ARE1 close to person Lf at high illuminance, and illuminates peripheral area ARE2 at low luminance, in illumination area ARE (see FIG. 10) illuminated by illuminator 41. Here, illuminator 41 can illuminate by switching to two stages of high illuminance and low illuminance, but illumination area ARE may be divided into three or more areas and each area may be illuminated by illuminance of three or more stages, or the illumination may be gradually changed in illumination area ARE without dividing the area.

Controller MP controls the entire lighting device LT, and is configured by a microprocessor or the like. Controller MP notifies projector PJ and illumination device BL of information on the position and movement direction of the person recognized by camera CA. In addition, controller MP transmits the information (detection information) on the position and movement direction of the person recognized by camera CA to control device 10 through network NW.

The function of controller MP may be provided in any one of camera CA, projector PJ, and illumination device BL, and in this case, controller MP can be omitted. In addition, in the present exemplary embodiment, lighting device LT is an integrated device including camera CA, projector PJ, and illumination device BL, but may be configured to include a camera, a projector, and an illumination device as a separate device.

Control device 10 selects lighting device LT which illuminates the front of a person in a movement direction of the person from among the plurality of lighting devices LT, based on the detection information of camera CA transmitted from controller MP, and instructs selected lighting device LT to light up. In addition, control device 10 selects projector PJ that projects a projection image onto the front side of the person in the movement direction of the person from among the plurality of projectors PJ, based on the detection information of camera CA transmitted from controller MP, and instructs selected projector PJ to project the projection image without instructing illumination device BL to light up (that is, stopping the lighting instruction to the illumination device BL), or in a state where the light instruction to the illumination device BL is continued. In a case where the plurality of illumination devices BL can illuminate the front of a person, control device 10 selects illumination device BL which illuminates so as not to form a shadow of the person. In the same manner, in a case where the plurality of projectors PJ can project a projection image in front of the person, control device 10 selects projector PJ that projects the projection image so as not to form a shadow of the person.

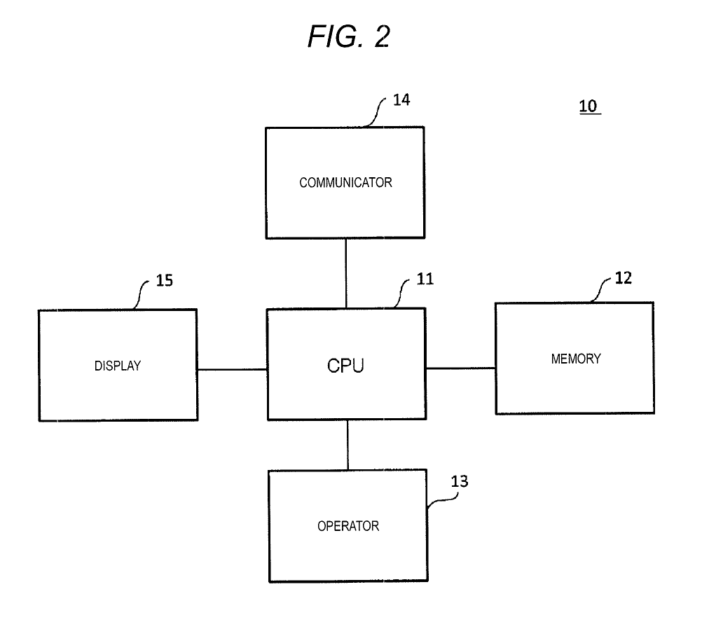

FIG. 2 is a block diagram illustrating an example of a configuration of control device 10. Control device 10 is a cloud computer connected to the plurality of lighting devices LT through network NW, and includes CPU 11, memory 12, operator 13, communicator 14, and display 15.

CPU 11 controls an operation of control device 10 in accordance with a program and data stored in memory 12. That is, CPU 11 performs signal processing of collectively controlling operations of each unit of control device 10, input and output processing of data to and from other units, calculation processing of the data, and storage processing of the data.

Memory 12 is configured by using, for example, a random access memory (RAM), a read only memory (ROM), and a nonvolatile or volatile semiconductor memory, functions as a work memory when CPU 11 operates, and stores a predetermined program and data for operating CPU 11.

Operator 13 receives an operation input by an observer or the like, based on an image displayed on display 15.

Communicator 14 communicates with the plurality of lighting devices LT connected to network NW, receives video data from each lighting device LT, and gives various instructions to each lighting device LT. In the present exemplary embodiment, control device 10 is a cloud computer connected to network NW, but may be mounted on camera CA of lighting device LT, or may be mounted on a server directly connected to the plurality of lighting devices LT without being connected through a network.

Display 15 displays an image captured by camera CA of lighting device LT.

FIG. 3 is a view schematically illustrating appearance of head hd of lighting device LT. Capture 21 of camera CA is disposed in the center portion of the front surface (irradiation surface) of head hd. The plurality of LEDs 55 which are point light sources are arranged around capture 21. For example, the plurality of LEDs 55 configure illuminator 41 and projector 31. That is, a part of the plurality of LEDs 55 is used as illuminator 41 for illumination, and the other parts are used as projector 31 for projecting the projection image.

All LEDs 55 may be switched as dedicated illumination or dedicated projection. For example, the illuminator 41 illuminates as illuminator 41 by turning on all LEDs 55, and projector 31 may use all LEDs 55 to project a projection image such that the projection image can be expressed by turning on/turning off each LED 55. In addition, projector 31 may be configured by a light source device different from head hd. In the same manner, illuminator 41 may be configured by a light source device different from head hd. In addition, in the present exemplary embodiment, the plurality of LEDs 55 and capture 21 are disposed in substantially one surface and close to each other on the front face of head hd, but may be disposed to be separate.

FIG. 4 is a view illustrating an outline of a projection operation of illumination system 5. Lighting devices LT are installed at a constant interval (substantially equal interval) beside sidewalk RD. Lighting device LT is a hangover type lighting device in which pole PL serving as a support stand uprights with respect to a road surface and is curved upward and head hd is attached to a tip portion thereof. Head hd is slightly inclined with respect to the road surface so as to illuminate the sidewalk RD obliquely. In FIG. 4, person Lf walks from near lighting device LT1 toward lighting device LT2. Lighting device LT1 does not project projection image PG1 in front of person Lf in a movement direction of the person, but lighting device LT2 projects projection image PG1 onto the front of the person Lf in the movement direction of person Lf. As an example, projection image PG1 projected here is an arrow image indicating a travel direction.

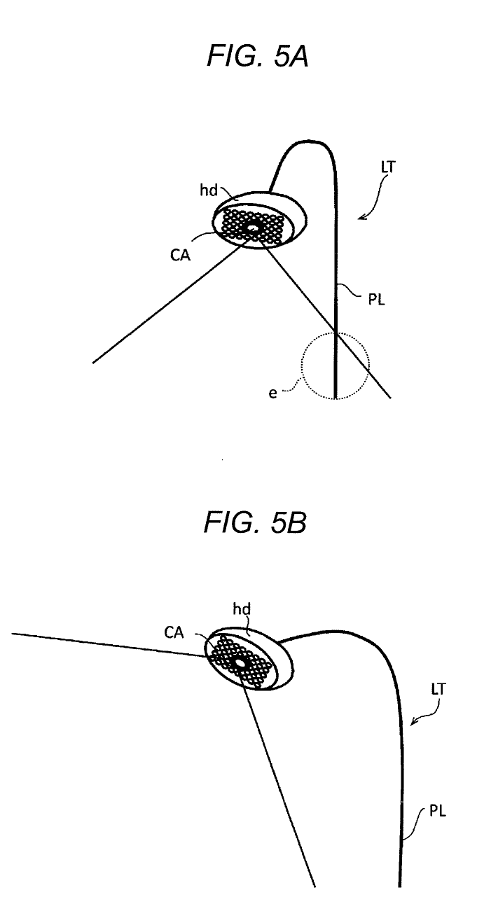

FIGS. 5A and 5B are views illustrating a positional relationship between pole PL and camera CA. FIG. 5A is a view illustrating a case where pole PL is within a photography angle of view of camera CA, as denoted by dotted line frame e. In this case, a blind spot (that is, a portion where a clear image is not obtained) occurs in a captured image of camera CA. Meanwhile, FIG. 5B is a view illustrating a case where pole PL is not within the photography angle of view by capture 21 of camera CA. Thus, the blind spot (that is, the portion where the clear image is not obtained) does not occur in the captured image of camera CA. In the present exemplary embodiment, head hd curved from above pole PL is attached so as to be separated from pole PL in the horizontal direction. In addition, an image capturing surface of head hd obliquely places in a direction opposite to pole PL. Thereby, camera CA can capture an image without blind spots.

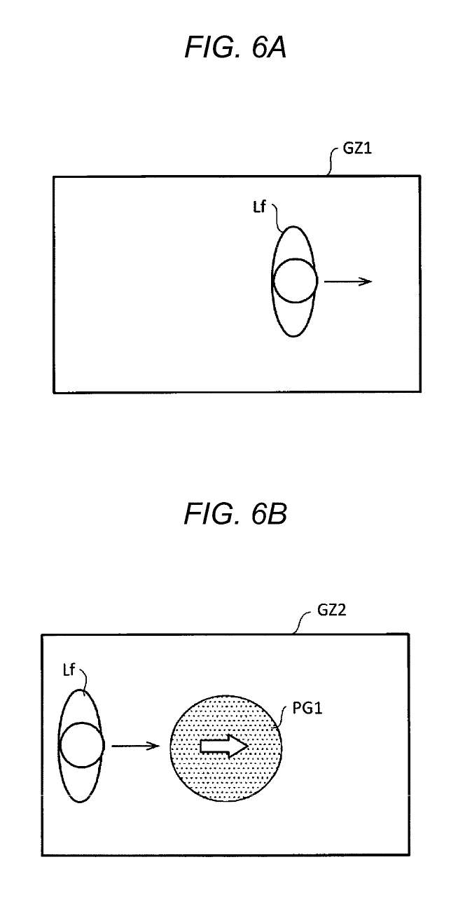

FIGS. 6A and 6B are views illustrating images captured by cameras CA1 and CA2 provided in two lighting devices LT1 and LT2, respectively. FIG. 6A is a view illustrating image GZ1 captured by camera CA1 of one lighting device LT1. FIG. 6B is a view illustrating image GZ2 captured by camera CA2 of the other lighting device LT2.

Person Lf appears in image GZ1 captured by camera CA1, but the image deviates from a region where projection image PG1 is projected. Therefore, projector PJ does not project the projection image under determination of controller MP. Meanwhile, person Lf appears on the left side in image GZ2 captured by camera CA2. Therefore, projector PJ projects projection image PG1 by setting the front of person Lf as a projection position under the determination of the controller MP. Here, projection image PG1 is an arrow image indicating a travel direction, but the projection image may be an image indicating a message such as a store mark as an advertisement or “there is an intersection 50 m ahead” as a guide.

In addition, in a case where a time zone in which projector PJ projects projection image PG 1 is dark around night or the like under the determination of controller MP, illumination device BL may illuminate a region (for example, a region having a predetermined area in front of person Lf). The same will be applied hereinafter) ahead of person Lf. In this case, a range illuminated by illumination device BL may partially overlap projection image PG1 projected by projector PJ or may be separated. In addition, in a case where illumination device BL overlaps the projection image PG1 for illumination, luminance of the central portion may be higher than the surrounding luminance in order to highlight advertisements and guidance desired to pay attention.

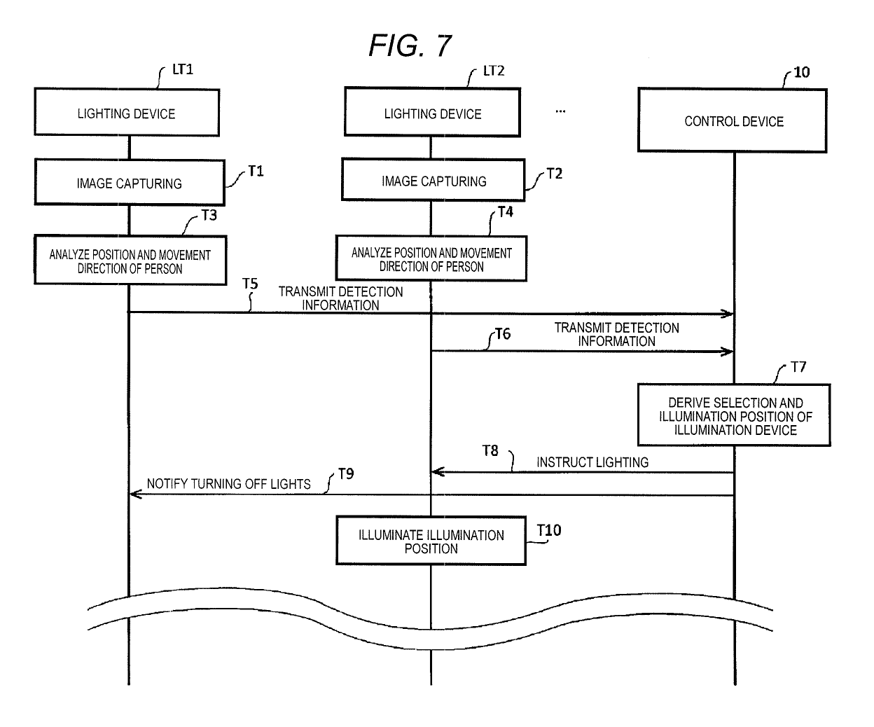

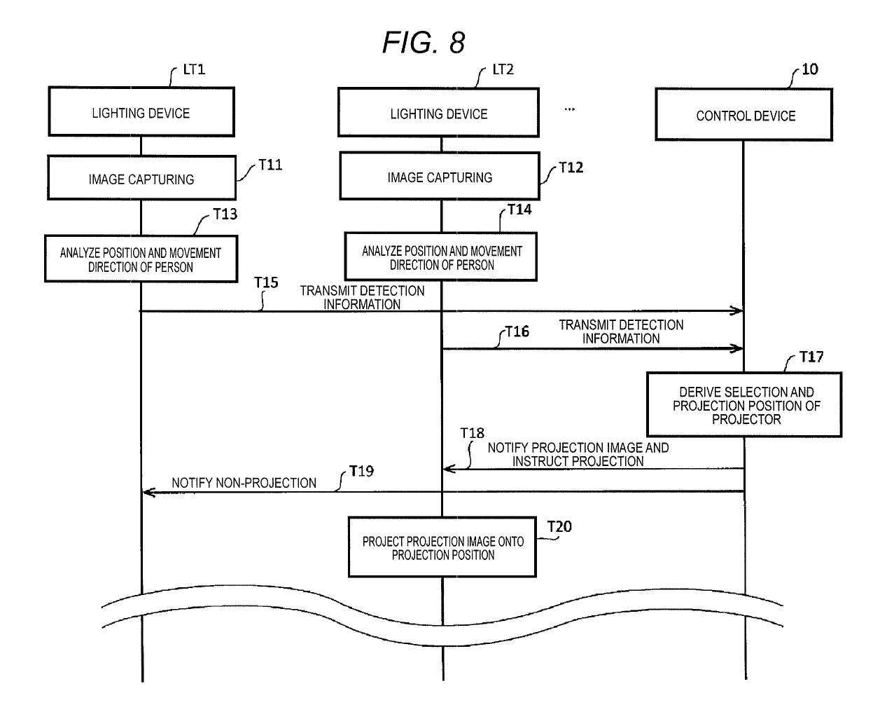

Next, an operation of illumination system 5 according to the first exemplary embodiment will be described with reference to FIGS. 7 and 8.

FIG. 7 is a sequence diagram of an illumination operation of illumination system 5 according to the first exemplary embodiment.

In FIG. 7, if illumination system 5 is activated, lighting device LT1 starts image capturing performed by camera CA1 (T1). In addition, lighting device LT2 starts image capturing performed by camera CA2 at the same time or sequentially with lighting device LT1 (T2). Here, only lighting devices LT1 and LT2 will be described, but the same is applied to other lighting devices LT. In a case where illumination device BL of the plurality of lighting devices LT can illuminate the front of a person, control device 10 selects illumination device BL which illuminates so as not to form a shadow of the person. Thereby, it is possible to brightly illuminate the front of person Lf without forming a shadow of moving person Lf.

If person position detector 22 of camera CA1 of lighting device LT1 processes the captured image and analyzes a position and a movement direction of person Lf (T3), controller MP of lighting device LT1 transmits detection information including the position and movement direction of the person recognized by camera CA1 to control device 10 through network NW (T5). In the same manner, if person position detector 22 of camera CA2 of lighting device LT2 processes the captured image and analyzes the position and the movement direction of person Lf (T4), controller MP of lighting device LT2 transmits detection information generated by camera CA2 to control device 10 through network NW (T6).

Control device 10 selects lighting device LT including illumination device BL that illuminates a region in front of person Lf in the movement direction of the person from among the plurality of illumination devices BL, based on the detection information of camera CA transmitted from controller MP of each lighting device LT (T7). Here, a case where lighting device LT2 is selected and lighting device LT1 is not selected is illustrated. In addition, in sequence T7, control device 10 derives an illumination position, based on information (the detection information) which is transmitted from controller MP of lighting device LT2 and relates to the position and movement direction of the person recognized by camera CA2. The illumination position may be, for example, a position 5 m ahead in the movement direction in front of a person.

Control device 10 instructs illumination device BL of selected lighting device LT to light the derived illumination position (T8). Meanwhile, control device 10 notifies lighting device LT1 to turn off lights (non-lighting) (T9). Sequence T9 may be omitted without notifying anything.

If lighting device LT2 receives an instruction to light up from control device 10, illumination device BL of lighting device LT2 illuminates the illumination position included in the instruction (T10). Thereafter, the same operation is repeated in time series until illumination system 5 stops.

FIG. 8 is a sequence diagram of projection operation of illumination system 5 according to the first exemplary embodiment.

In FIG. 8, if illumination system 5 is activated, lighting device LT1 starts image capturing performed by camera CA1 (T11). In addition, lighting device LT2 starts image capturing performed by camera CA2 at the same time or sequentially with lighting device LT1 (T12). Here, only lighting devices LT1 and LT2 will be described, but the same is applied to other lighting devices LT.

If person position detector 22 of camera CA1 of lighting device LT1 processes the captured image and analyzes the position and movement direction of person Lf (T13), controller MP of lighting device LT1 transmits detection information including the position and movement direction of the person recognized by camera CA1 to control device 10 through network NW (T5). In the same manner, if person position detector 22 of camera CA2 of lighting device LT2 processes the captured image and analyzes the position and movement direction of person Lf (T14), controller MP of lighting device LT2 transmits detection information including generated by camera CA2 to control device 10 through network NW (T16).

Control device 10 selects lighting device LT including projector PJ that illuminates an image in front of person Lf in the movement direction of the person from among the plurality of projectors PJ, based on the detection information of camera CA transmitted from controller MP of each lighting device LT (T17). Here, a case where lighting device LT2 is selected and lighting device LT1 is not selected is illustrated. In a case where projector PJ of the plurality of lighting devices LT can project a projection image in a region in front of the person, control device 10 selects projector PJ that projects the projection image so as not to form a shadow of a person. For example, in FIG. 4, projector PJ1 of lighting device LT1 is not selected because the projection image contains the shadow of person Lf. Thereby, it is possible to project the projection image desired to pay attention to person Lf in a perfect form without partial damage.

In addition, in sequence T17, control device 10 derives a projection position of the projection image, based on information (detection information) which is transmitted from controller MP of lighting device LT2 and relates to the position and movement direction of the person recognized by camera CA2. The projection position may be, for example, a position 5 m ahead in the movement direction in front of the person.

Control device 10 notifies projector PJ of selected lighting device LT of the projection image and instructs projection to a derived projection position (T18). Meanwhile, control device 10 notifies lighting device LT1 of non-projection (T19). Sequence T9 may be omitted without notifying anything.

If lighting device LT2 receives an instruction of projection from control device 10, projector PJ of lighting device LT2 projects the projection image onto a projection position included in the instruction (T20). Thereafter, the same operation is repeated in time series until illumination system 5 stops.

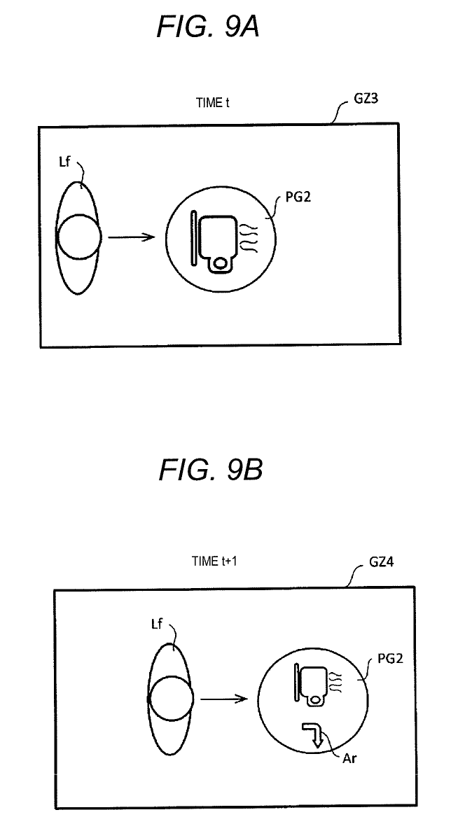

FIGS. 9A and 9B are views illustrating images captured by camera CA2 of lighting device LT2 in time series. FIG. 9A is a view illustrating captured image GZ3 at time t. FIG. 9B is a view illustrating captured image GZ4 at time t+1. At time t, person Lf is located on the left side of the page of FIG. 9A of the captured image, and projection image PG2 is located at the center of the page of FIG. 9A. Projection image PG2 is an advertisement image of a coffee shop located in the vicinity. At time t+1, person Lf moves in the right direction of the page of FIG. 9A, and accordingly projection image PG2 also moves in the right direction of the page of FIG. 9A. At this time, projection image PG2 changes to an advertisement image to which arrow Ar indicating a direction of a coffee shop is added.

As described above, in illumination system 5 according to the first exemplary embodiment, a plurality of cameras CA and a plurality of illumination devices BL installed in sidewalk RD (an example of an area) where person Lf moves, and control device 10 are connected to each other through network NW. Each camera CA transmits the detection information including the position and the movement direction of person Lf to control device 10. Control device 10 selects illumination device BL that illuminates a region in front of the person in the movement direction of the person from among the plurality of illumination devices BL, based on the detection information transmitted from each of the cameras CA, and instructs selected illumination device BL to light up.

Thereby, illumination system 5 can accurately illuminate a region in front of a person in of a movement direction of the person in accordance with movement of the person such as a pedestrian. As such, since the illumination system 5 can illuminate in consideration of the movement of the person (mobile object) when illuminating in a case of detecting a person, it is possible to considerably reduce an increase in total power consumption, compared with a case of illuminating all street lights.

In addition, in illumination system 5 according to the first exemplary embodiment, a plurality of projectors PJ (projection devices) installed in an area such as sidewalk RD are connected through network NW. Control device 10 selects projector PJ that projects a projection image (PJ image) onto a region in front of person Lf in of the movement direction of the person from among the plurality of projectors PJ, based on the detection information transmitted from each camera CA, and does not instruct illumination device BL to light up (that is, lighting instruction to illumination device BL is stopped), or instructs selected projector PJ to project in a state where lighting instruction to illumination device BL is continued. Thereby, illumination system 5 can accurately project the projection image into a region (that is, a position where a person such as a pedestrian can easily pay attention to) in front of the person in the movement direction of the person.

In addition, control device 10 selects projector PJ that projects a projection image from among the plurality of projectors PJ so as not to form a shadow of person Lf. Thereby, illumination system 5 can project the projection image desired to pay attention to person Lf in a perfect form without partial damage. In addition, even in a case where of illumination, the illumination system 5 can brightly illuminate the front of person Lf without forming a shadow of moving person Lf.

In addition, in a case where camera CA is attached to pole PL (support stand) installed in a specific area, capture 21 of camera CA is disposed to a position separated from pole PL such that pole PL is not within the photography angle of view of camera CA. Thereby, camera CA can capture an image without blind spots.

### Second Exemplary Embodiment

In the first exemplary embodiment, illumination device BL illuminates with a uniform light amount. However, in a second exemplary embodiment, an example in which illumination device BL illuminates with different light amounts depending on a position from person Lf will be described.

In addition, an illumination system according to the second exemplary embodiment has substantially the same configuration as the illumination system according to the first exemplary embodiment. The same reference numerals or symbols will be attached to the same configuration elements as those in the first exemplary embodiment, and description thereof will be omitted.

FIG. 10 is a view illustrating an outline of an illumination operation of lighting device LT according to the second exemplary embodiment. Illumination device BL of lighting device LT illuminates a region in front of person Lf walking on sidewalk RD and a surrounding region thereof. In illumination area ARE, front area ARE1 close to person Lf is illuminated at high illuminance, and peripheral area ARE2 is illuminated at low illuminance. It is easy for person Lf to conspicuously walk to front area ARE1 which is a destination forward. In addition, since illuminance of peripheral area ARE2 is low as compared with a case of illuminating all illumination areas ARE at high illuminance, power consumption is reduced.

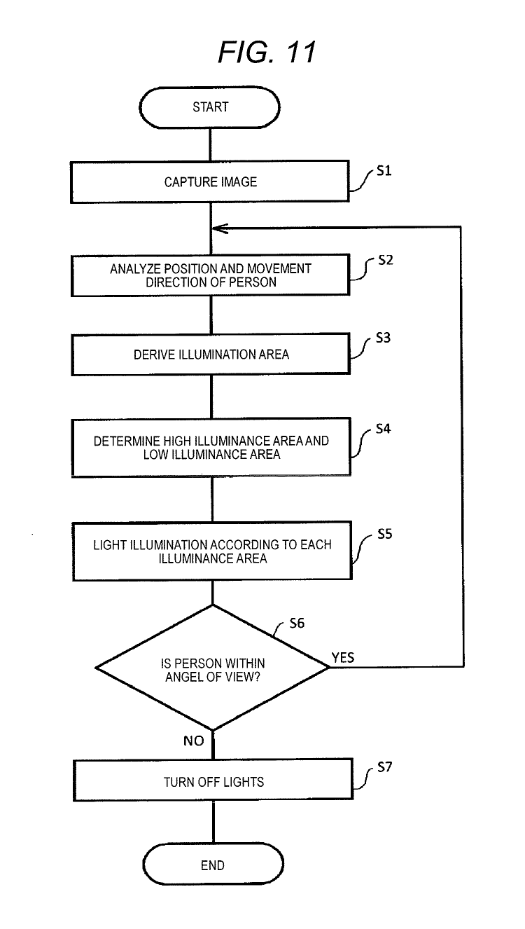

FIG. 11 is a flowchart illustrating an illumination operation sequence of illumination system 5 according to the second exemplary embodiment.

In FIG. 11, if lighting device LT is activated, camera CA starts image capturing (S1). Person position detector 22 of camera CA analyzes an image captured by capture 21, detects a position and a movement direction of person Lf appearing in the image, and outputs results to illumination position controller 42 through controller MP (S2). If the position and the movement direction of person Lf are acquired from person position detector 22 through controller MP, illumination position controller 42 derives illumination area ARE (S3).

When deriving illumination area ARE, illumination position controller 42 determines front area ARE1 close to person Lf as a high illuminance area and peripheral area ARE2 thereof as a low illuminance area, and gives an instruction to illuminator 41 (S4). If receiving the instruction from illumination position controller 42, illuminator 41 is lighted and illuminates each area with the instructed illuminance (S5).

Thereafter, camera CA determines whether or not person Lf exists within the photography angle of view (S6). In a case where person Lf exists within the photography angle of view, processing returns to step S2. Meanwhile, in a case where person Lf does not exist within the photography angle of view, illuminator 41 turns off lights (S7) and the present processing ends.

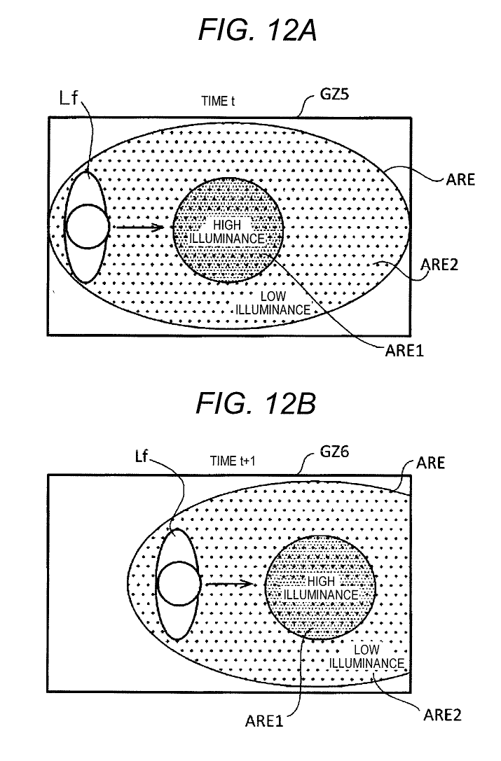

FIGS. 12A and 12B are views illustrating images captured in time series by camera CA of lighting device LT. FIG. 12A is a view illustrating the captured image at time t. FIG. 12B is a view illustrating the captured image at time t+1. At time t, person Lf is located on the left side of the page of FIG. 12A of captured image GZ5. Illumination area ARE illuminated by illuminator 41 is a region in front of person Lf in a movement direction of the person and is located substantially at the center of captured image GZ5. Illuminator 41 illuminates front area ARE1 of illumination area ARE at high illuminance and illuminates peripheral area ARE2 at low illuminance. At time t+1, person Lf moves in the right direction of the page of FIG. 12A, and accordingly illumination area ARE also moves in the right direction of the page of FIG. 12A. A part of the right side of peripheral area ARE2 deviates from captured image GZ6.

As such, in illumination system 5 according to the second exemplary embodiment, internal front area ARE1 in illumination area ARE illuminated by illumination device BL is lighted so as to have a higher illuminance than peripheral area ARE2 thereof and thereby, the front of person Lf can be brightly illuminated. In addition, peripheral illuminance is lowered, and thereby, power can be saved.

### First Modification Example

In the first exemplary embodiment, projector PJ sets a position separated by a predetermined constant distance (fixed value) in front of a position of a person in the movement direction as a projection position, and projects the projection image onto the position, and illumination device BL illuminates the same position by setting the same position as an illumination position. In addition, in the second exemplary embodiment, illumination device BL sets the position separated by a predetermined constant distance (fixed value) in front of the position of the person in the movement direction as an illumination position, and illuminates the front area at high illuminance and the peripheral area low illuminance. In contrast to this, the first modification example illustrates a case where a movement speed (walking speed) of the person is measured and the projection position or the illumination position is set according to the movement speed of the person.

The movement speed (walking speed) of the person can be measured by, for example, the following method. Projector PJ projects a predetermined zebra pattern onto a road surface of sidewalk RD. For example, an interval (distance) of the zebra pattern is constant on the road surface on which the zebra pattern is projected. Here, the zebra pattern is projected such that the interval of the zebra pattern is constant, but as long as the interval of the zebra pattern is known, the interval of the zebra pattern may not be constant as in a case where the interval of the zebra pattern is obliquely projected.

Camera CA captures an image of a road surface on which the zebra pattern is projected. If person Lf exists on the road surface on which the zebra pattern is projected in the image captured by camera CA, distortion based on person Lf occurs in the image (that is, the captured image) of the zebra pattern due to influence of reflection of ambient light (for example, visible light) on person Lf. For example, by measuring a distortion interval of the zebra pattern in two images with different image capturing times which is captured by camera CA, and dividing the measured interval (distance) by an image capturing time difference between two images, a walking speed of a person can be derived.

In a case where the derived walking speed of the person is fast, projector PJ sets a position far away from the position of the person as a projection position, and in a case where the walking speed of the person is slow, the projector sets a position close to the position of the person as the projection position. In the same manner, in a case where the walking speed of the person is fast, the illumination device BL sets the position far away from the position of the person as an illumination position, and in a case where the walking speed of the person is slow, the illumination device BL sets the position close to the position of the person as the illumination position.

In the illumination system according to the first modification example, projector PJ projects a predetermined zebra pattern onto an area. Camera CA measures a movement speed of person Lf in a specific area where the zebra pattern is projected. Control device 10 determines at least one of the illumination position illuminated by illumination device BL and the projection position to which projector PJ projects the projection image, using the movement speed of person Lf measured by camera CA. Thereby, illumination system 5 can project and illuminate the projection image at an appropriate position according to the movement speed of person Lf.

### Second Modification Example

In the first modification example, the projection position or the illumination position is set according to the movement speed of the person, but in the second modification example, a case of setting the projection position or the illumination position according to a height of a person is described. The height of the person can be derived by, for example, the following three methods.

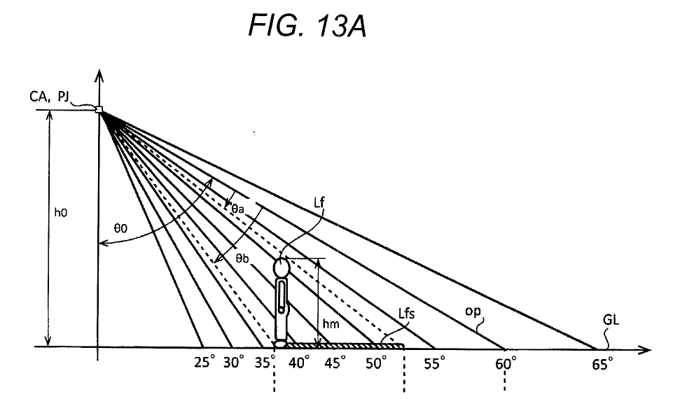

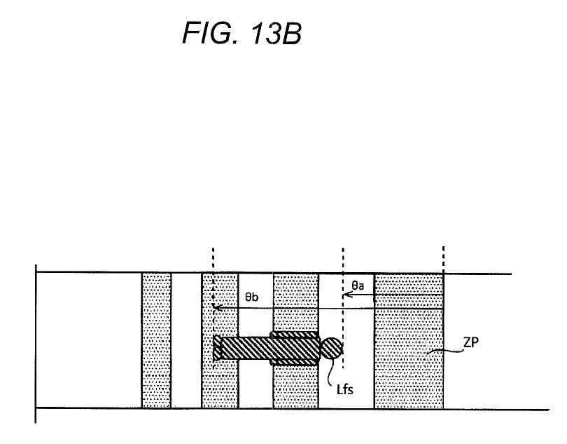

A first method is a case where projector PJ and camera CA are installed at substantially the same place. FIGS. 13A and 13B are views illustrating the first method of projecting zebra pattern ZP to obtain a height of person Lf. FIG. 13A is the view of lighting device LT and person Lf viewed in a lateral direction. FIG. 13B is the view of shadow LFs of lighting device LT and person Lf viewed from a top.

Here, h0 is a distance (height of a person) from road surface GL to projector PJ and illumination device BL, and is a known value determined by an installation position of lighting device LT. θ0 is an angle of optical axis op around a position of projector PJ and is a known value determined by the installation position of the lighting device LT. θa is an angle from optical axis op around a position of projector PJ to a straight line passing through a head tip of person Lf. θb is an angle from optical axis op around a position of projector PJ to a straight line passing through the foot of person Lf. hm is a height (height) of person Lf.

If illumination device BL illuminates, shadow Lfs of person Lf is formed on road surface GL. The shadow of person Lf is represented by Equation (1).

hm×tan(θ0−θa)=h0×tan(θ0−θa)−h0×tan(θ0−θb) (1)

From Equation (1), the height of person Lf is represented by Equation (2).

$$hm = \frac{h 0 \times tan ( θ0 - θ a ) - h 0 \times tan ( θ0 - θ b )}{tan ( θ 0 - θ a )} \qquad ( 2 )$$

In addition, angle θa of the head tip of person Lf and angle θb of a toe of person Lf appear in an image captured by camera CA and are obtained from shadow Lfs of person Lf overlapped in zebra pattern ZP. For example, in a case of FIG. 13A, θ0=60°, θa=8°, θb=24°. If the values are inserted into Equation (2), height hm of person Lf is calculated.

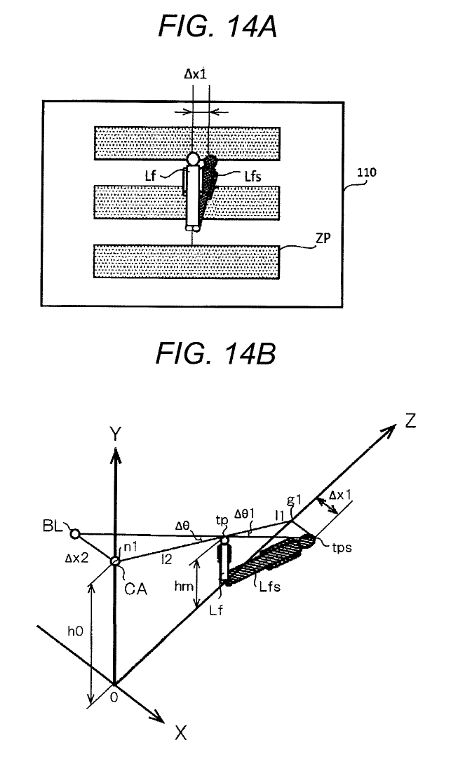

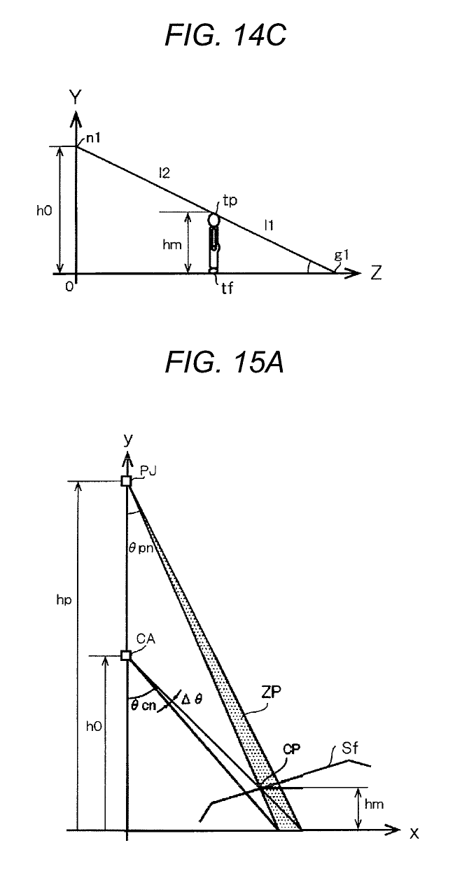

The second method is a case where heights of projector PJ and camera CA in the vertical direction with respect to the road surface are the same and projector PJ and camera CA are installed at positions separated from each other in the horizontal direction. FIGS. 14A and 14B are views illustrating the second method of projecting zebra pattern ZP to obtain the height of person Lf. FIG. 14A is a monitor screen displaying the image captured by camera CA. FIG. 14B is a view illustrating a positional relationship between illumination device BL, camera CA, and person Lf. Here, for the sake of convenience, a direction from lighting device LT to the foot of person Lf is referred to as the Z-axis direction on the road surface GL, a direction orthogonal to the Z-axis direction from lighting device LT is referred to as the X-axis direction on the road surface GL, and a direction perpendicular from lighting device LT is referred to as the Y-axis direction on the road surface GL. FIG. 14C is a view illustrating a Y-Z plane of FIG. 14B.

Camera CA is installed on the Y axis. Illumination device BL is installed to be separated from camera CA in the X direction at the same Y-axis height as camera CA. Since illumination device BL is separated from camera CA in the horizontal direction (X-axis direction) on monitor screen 110, shadow Lfs is displayed obliquely with respect to person Lf.

Here, Δx2 represents a distance between illumination device BL and camera CA and is a known value. Δx1 represents a distance from the Z axis of shadow Lfs. l2 represents a distance between head tip tp of person Lf and camera CA. If a point where a straight line passing through head tip tp of person Lf and position n1 of camera CA intersects road surface GL is referred to as point g1 on road surface GL, l1 represents a distance between head tip tp of person Lf and point g1 on road surface GL. Δθ represents an angle between camera CA and illumination device BL centered on head tip tp of person Lf.

A triangle formed by illumination device BL and camera CA having head tip tp of person Lf as an apex is similar to a triangle formed by point g1 of road surface GL and head tip tps of shadow Lfs having the head tip tp of person Lf as an apex. Accordingly, a relationship of Equation (3) is established.

$$l 2 = \frac{Δ x 2}{Δ x 1} \times l 1 \qquad ( 3 )$$

In addition, as is clear from FIG. 14C, a triangle formed by position n1 of camera CA and starting point 0 having point g1 of road surface GL as an apex is similar to a triangle formed by head tip tp of person Lf and underlying point tf having point g1 of road surface GL as an apex. Accordingly, a relationship of Equation (4) is established.

$$hm = \frac{l 1}{l 1 + l 2} \times h 0 \qquad ( 4 )$$

If l2 represented by Equation (3) is inserted into Equation (4), Equation (5) is obtained.

$$hm = h 0 \times \frac{1}{1 + \frac{Δ x 2}{Δ x 1}} \qquad ( 5 )$$

As illustrated in FIG. 14A, Δx1 is obtained from the image captured by camera CA, and Δx2 is a known value, and thus, height hm of person Lf is calculated by inserting the values into Equation (5).

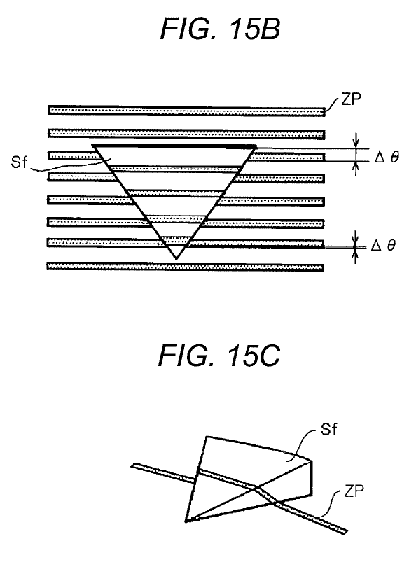

The third method is a case where projector PJ and camera CA are the same at a position in the horizontal direction with respect to the road surface, and are installed at positions separated in the vertical direction. FIGS. 15A, 15B, and 15C are views illustrating the third method of projecting zebra pattern ZP to obtain the height of person Lf. FIG. 15A is a view illustrating the projection position of projector PJ and the image capturing position of camera CA. FIG. 15B is a view illustrating an image of zebra pattern ZP captured by camera CA. FIG. 15C is a view illustrating the distortion of zebra pattern ZP in a case where object surface Sf exists in a projection direction of projector PJ.

In a case where projector PJ projects zebra pattern ZP, if object surface Sf of a person or the like exists, camera CA disposed below projector PJ captures an image assuming that zebra pattern ZP exists behind a position of projected zebra pattern ZP, as illustrated in FIGS. 15B and 15C. Projector PJ projects zebra pattern ZP according to Equation (6). In this case, the horizontal axis becomes the x axis and the vertical axis becomes the y axis.

$$y = \frac{1}{x \times tan θ pn + h p} \qquad ( 6 )$$

Here, hp represents the height of projector PJ. θpn represents an angle at which projector PJ projects an image onto road surface GL and is known.

Meanwhile, camera CA captures an image of zebra pattern ZP according to Equation (7).

$$y = x \times \frac{1}{tan ( θ cn + Δθ )} + hc \qquad ( 7 )$$

Here, in a case where there is no object surface such as a person, θcn represents an angle of zebra pattern ZP which is captured by camera CA and is projected on road surface GL, and is known. In a case where there is object surface Sf of a person or the like, Δθ represents an angular deviation of zebra pattern ZP which is captured by camera CA and is projected onto object surface Sf. As illustrated in FIG. 15B, Δθ representing the angular deviation of zebra pattern ZP projected onto object surface Sf is obtained from the distortion of zebra pattern ZP captured by camera CA.

Intersection point CP denoted by the two straight lines represents coordinates of the zebra pattern projected onto the object surface, that is, the head tip of the person. Accordingly, Y coordinates of intersection point CP correspond to height hm of the person. The Y coordinates of intersection point CP represented by the two straight lines, that is, height hm of the person is represented by Equation (8).

$$hm = \frac{\{ h p \times tan θ p n - hc \times tan ( θ cn + Δθ ) \}}{tan θ pn - tan ( θ cn + Δθ )} \qquad ( 8 )$$

Accordingly, in a case where there is object surface Sf of a person or the like, Δθ representing the angular deviation of zebra pattern ZP which is captured by camera CA and is projected onto object surface Sf is obtained, and thereby, height (height of a person) hm of the person is obtained.

If the height of a person is derived by any one of the above three methods, projector PJ sets a position far away from a position of the person as a projection position in a case where the height of the person is high, and projector PJ set a position close to the position of the person is as the projection position in a case where the height of the person is low. In the same manner, in a case where the height of the person is high, the illumination device BL sets a position far away from the position of the person as an illumination position, and in a case where the height of the person is low, the illumination device BL sets a position close to the position of the person as the illumination position.

In the illumination system according to the second modification example, projector PJ projects predetermined zebra pattern ZP onto an area. Camera CA measures the height of person Lf in a specific area where zebra pattern ZP is projected. Control device 10 determines at least one of the illumination position illuminated by illumination device BL and the projection position where projector PJ projects the projection image, using the height of person Lf measured by camera CA. Thereby, illumination system 5 can project or illuminate the projection image to an appropriate position according to the height of person Lf. Control device 10 may determine the projection position or the illumination position in consideration of both the movement speed of the person derived in the first modification example and the height of the person derived in the second modification example.

As described above, various embodiments are described with reference to the drawings, and it is needless to say that the present disclosure is not limited to the examples. It is obvious to those skilled in the art that various modifications or modification examples can be derived within the scope described in the Claims, and it should be understood that these naturally belong to the technical scope of the present disclosure.

For example, in the aforementioned embodiments, a distance to a person is detected by using an image captured by a camera, but may be detected by using a time of flight (TOF) sensor instead of the camera. The TOF sensor measures a distance to a subject by emitting infrared rays or ultrasonic waves. In addition, the distance to the subject may be detected by triangulation, using a range finder.

In addition, in the aforementioned embodiments, a projection operation and an illumination operation of a projection image are separately performed, but the operations may be simultaneously performed. That is, the front of a person may be illuminated and the projection image may be projected forward. Thereby, while the front is illuminated, an image desired to be pay attention, such as advertisements or guidance can be presented to a person.

In addition, in the aforementioned embodiments, a person is assumed as a moving object, but the present disclosure can be applied to a car, a robot, an animal such as a pet, and the like in the same manner.

In addition, the present disclosure provides a program that realizes a function of the illumination system according to the aforementioned embodiments to a device through a network or various storage media, and a program that is read and executed by a computer in the device is also within an application range.

The present disclosure is useful for an illumination system, an illumination method, and a program that can illuminate in consideration of movement of a person such as a pedestrian.

What is claimed is:

1. An illumination system comprising:
a plurality of cameras;
a plurality of illumination devices; and
a control device,
wherein the cameras and the illumination devices are installed in an area where a person moves, and are connected to the control device through a network,
wherein each of the cameras, in operation, transmits detection information including a position and a movement direction of the person in the area to the control device, and
wherein the control device, in operation, selects the illumination device that illuminates a region in front of the person in the area in the movement direction of the person, from among the plurality of illumination devices, based on the detection information which is transmitted from each of the cameras, and further instructs the selected illumination device to light up.

2. The illumination system of claim 1,
wherein a plurality of projection devices that are installed in the area are further connected to each other through the network,
wherein the control device, in operation, selects the projection device that projects a projection image onto a region in front of the person in the area in the movement direction of the person, from among the plurality of projection devices, based on the detection information which is transmitted from each of the cameras, and
wherein the control device, in operation, instructs projection of the projection image to the selected projection device, in a state where the lighting instruction to the illumination device is stopped or continued.

3. The illumination system of claim 2,
wherein the projection device, in operation, projects a predetermined zebra pattern onto the area,
wherein each of the cameras, in operation, measures a movement speed of a person in a position where the zebra pattern is projected, based on the zebra pattern, and
wherein the control device, in operation, determines at least one of an illumination position that is illuminated by the illumination device and a projection position onto which the projection device projects the projection image, using the movement speed of the person which is measured by the camera.

4. The illumination system of claim 2,
wherein the projection device, in operation, projects a predetermined zebra pattern onto the area,
wherein the camera, in operation, measures a height of a person in a position where the zebra pattern is projected, based on the zebra pattern, and
wherein the control device, in operation, determines at least one of an illumination position that is illuminated by the illumination device and a projection position onto which the projection device projects the projection image, using the height of the person which is measured by the camera.

5. The illumination system of claim 2, wherein the control device, in operation, selects a projection device that projects the projection image, from among the plurality of projection devices so as not to form a shadow of the person.

6. The illumination system of claim 1, wherein, in a case where the camera is attached to a support stand that is installed in the area, a capture of the camera is disposed in a position which is separated from the support stand such that the support stand is not within a photography angle of view of the camera.

7. The illumination system of claim 1, wherein an internal front area in an illumination area that is illuminated by the illumination device is lighted so as to have higher illuminance than a peripheral area thereof.

8. An illumination method of an illumination system in which a plurality of cameras and a plurality of illumination devices that are installed in an area where a person moves are connected to a control device through a network, the illumination method comprising:
transmitting detection information including a position and a movement direction of the person in the area to the control device by using each of the cameras, and
selecting the illumination device that illuminates a region in front of the person in the area in the movement direction of the person, from among the plurality of illumination devices, based on the detection information which is transmitted from each of the cameras, and further instructing the selected illumination device to light up, by using the control device.

9. A recording medium in which a program that can be read by a computer is stored, the recording medium storing a program which causes
a control device that is a computer and is connected through a network between a plurality of cameras and a plurality of illumination devices which are installed in an area where a person moves, to execute:
a step of selecting the illumination device that illuminates a region in front of the person in the area in the movement direction of the person, from among the plurality of illumination devices, based on the detection information which is transmitted from each of the cameras and includes a position and a movement direction of the person in the area; and
a step of instructing the selected illumination device to light up.
